(19) United States
(12) Patent Application Publication
(10) Pub. No.: US 2019/0044904 A1
(43) Pub. Date: Feb. 7, 2019

(54) Method for Managing Incoming Text Messages in Mobile Devices

(71) Applicants: Eliahu Antopolsky, Zichron Yaakov (IL); Meir Dahan, Adi (IL)

(72) Inventors: Eliahu Antopolsky, Zichron Yaakov (IL); Meir Dahan, Adi (IL)

(21) Appl. No.: 15/919,494

(22) Filed: Mar. 13, 2018

Related U.S. Application Data
(63) Continuation-in-part of application No. 15/665,427, filed on Aug. 1, 2017.

(51) Int. Cl. H04L 12/58; H04W 4/14; H04M 3/42

(52) U.S. Cl. CPC H04L 51/24; H04M 3/42382; H04W 4/14

(57) ABSTRACT

A method that enables a mobile device user to manage incoming text messages in a way that in a period of time that he sets the method prevents the operation of the alerts mechanisms of his mobile device. In case of an incoming text messages the method sends a notice to the sender mobile device notifying that the user prefers to receive now only urgent text messages. The method enables the sender to decide according to his sole discretion whether to complete this text messages in a way that the text messaged will be noticeable immediately or at the end of that time period.

### RELATED APPLICATIONS

This application is a continuation in part of U.S. patent application Ser. No. 15/665,427 filed on 1 Aug. 2017.

### TECHNICAL FIELD

The present invention refers generally to a method that may be performed by a processor running on mobile devices or on computers of phone service providers, which enables users to manage incoming text messages.

### BACKGROUND ART

Many users have on their mobile devices messaging applications that are designed to send and receive messages, that may include text messages, icons, photos, video and media files and the like (hereinafter “text messages”). Famous messaging applications are for example the standard cellular text messages applications and also the over internet applications such as WhtasApp, Viber, Line, Facebook Messenger, Skype and the like.

In many cases the incoming messages distract the users' mind when they are focusing in their activities, such as, driving, reading, writing, wondering, talking, cocking, working and the like. Many scientific studies have measured the bad effects of frequent distractions when a person is preoccupied with doing something or even at rest. For example, those studies show that such frequent distractions reduce a person's efficiency by about 20 IQ points and also harm his well-being and happiness. Regardless such harmful effects of frequent distractions it may be understood that many users wish to handle in real time only urgent important messages and to handle all other messages at a certain time convenient for them.

Many users of mobile devices that are designed to receive text messages are in dilemma whether to put their mobile device on mute mode when they are in places and situations when it is customary to put the mobile device on mute mode, such as a meeting, trying to take a nap or in a movie, while at the same time they prefer not to miss important and emergency incoming text messages. The dilemma of almost every average user is whether to leave the mobile device on the regular mode on these specific times and to receive unimportant incoming text messages, which are disturbing at that time, or to put it on mute and to miss important and emergency text messages. Many people hold the opinion that text messages should be answered as quickly as incoming calls, as opposed to e-mails for example.

An incoming text message make a triple trouble when it arrives at such times when the user wishes not to be disturbed: first, the notification of the incoming text messages disturbs the user in that times; Second, the notification itself followed by temptation of the user just to check briefly who sends the message and to find out its urgent importance; and Third, the user is likely to think that ignoring now the message is a dishonorable act to the sender, who may be offended. The present invention offers a good and effective response to this dilemma.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a block diagram that shows two mobile devices (200), one of them is the recipient mobile device (1) and the second one is the sender mobile device (2).

FIG. 2 is a block diagram that shows two mobile devices (200) that one of them is the mobile device (11) and the second one is the another mobile device (22).

FIG. 3 is a block diagram that shows the computer (500) of the phone service provider, the mobile device (520) of a sender and the mobile device (510) of the subscriber.

### THE INVENTION

For the sake of fluency we will start with some definitions. The terms hereinafter have the meanings as stated beside each of them in this patent application and in the claims as well. These terms may be used in the application and the claims in plural or singular.

The term “mobile device” refers to any kind of device which is designed to receive text messages, by cellular networks or internet, such as smartphones, tablet computers, wearable computers, etc.;

The term “text message” refers to text messages which may be executed also over cellular networks and messages over the internet by smartphone applications such as Viber, WhatsApp, FaceTime, Skype and Messenger;

The “sender” refers to a person who performs a text message by a mobile device;

The “recipient” refers to a person who receives a text message to a mobile device;

The term “user” refers to a recipient when this user receives a text message in his mobile device or to a sender when this user performs a text message by his mobile device;

The term “sender mobile device” refers to the mobile device that performs an outgoing text message;

The term “recipient mobile device” refers to the mobile device that receives an incoming text message;

The term “processing device” refers to a processing device on a remote server, or on a mobile device, or on both of them. The processing device may include computing device;

The term “alerts mechanisms” refers to the ringing, vibrating and screen display mechanisms and notifications of mobile devices, which usually are activated as a result of incoming text message.

The main object of the present patent application is to provide a method performed by processing devices (10) that enables users of mobile devices to manage incoming text messages. A smartphone application may be used as a framework for the overall operation of the method and for the sake of fluency we will use the terms “smartphone application” and “method” hereinafter in this connection and as having in general the same meanings. Users of mobile devices can download the smartphone application to their mobile devices. The smartphone application performs the method on the processing devices (10), which may be processing devices in the mobile devices, in remote servers (100) or on both.

The method performed by processing devices (10) running on mobile devices (200) and the remote server (100). The users of the mobile devices (200) may perform a text message and in these cases these users are senders and their mobile devices are sender mobile devices (2), or may receive a text message and in these cases these users are recipients and their mobile devices are recipient mobile devices (1). The method includes the following features:

(a) Enabling the user to activate the method regarding his mobile device for a period of time that this user sets. In this case we may refer to this user as a recipient and to his mobile device as a recipient mobile device (1). The method enables the recipient to manage incoming text messages to his recipient mobile device (1) in a way that incoming text messages will not activate the alerts mechanisms of his mobile device but only after a decision of the sender that the text message is urgent, a decision that is based on the sole discretion of the sender.
(b) In response to the activation of the method on the recipient mobile device (1), the method prevents the operation of the alerts mechanisms (3) of the recipient mobile device (1) in response to incoming text messages during this period of time that the recipient sets.
(c) In response to the activation of the method regarding the recipient mobile device (1), the method sends to the remote server (100) via internet the information regarding the phone number of the recipient mobile device (1) and regarding the period of time that he sets. The term “phone number” means the phone number of the recipient mobile device or any identification address in cases of messengers, Skype, Viber, WhatsApp and that kind of relevant text messages applications programs and providers.
(d) Storing in the remote server the information regarding the phone number of the recipient mobile device and listing for said period of time this phone number as a phone number on an urgent mode.
(e) in response to execution of a text message from the sender mobile device to another phone number, the method sends via internet from the sender mobile device (2) to the remote server (100) the information regarding the another phone number. The term “another phone number” means the phone number of the recipient mobile device or any identification address in cases of messengers, Skype and that kind of relevant text messages programs and providers, such as Viber, WhatsApp and the like.
(f) Checking in said remote server whether said another phone number is listed in the remote server as a phone number on an urgent mode.
(g) In response to a positive result of this checking, the method sends a notice to the sender mobile device that includes notification that the recipient prefers to receive now only urgent text message.
(h) Enabling the sender of the text message whether to complete the text message according to his sole discretion.
(i) In response to such decision to complete the text message, the method sends command from the remote server to the recipient mobile device (1) for enabling the operation of the alerts mechanisms (3) of the recipient mobile device (1) and by that enabling the recipient to be aware to the incoming text message.

The method also may include the following feature: When the sender mobile device does not include the method, then when this sender performs a text message to the recipient, the method sends to the sender mobile device a message that the recipient using this method and recommends the sender to download it for enabling him to complete the text message, a future text message and also for his own use.

The term “completed” in this connection and also in the claims means that the alerts mechanisms (3) of the recipient mobile device (1) will operate in response to the incoming text message, basically in the normal way when the method is on no-active mode, for example, ringing, vibrating and activating the screen with light and information regarding the incoming text message. In other words, the term “completed” means that the text message will be noticeable in real time, means immediately following sending the message. The term “noticeable” in this connection means that the mobile device of the user will alert in response to the incoming message and that the messaging application will present the message, basically in the normal way when the system is on no-active mode.

The notice informs the sender that the recipient prefers to receive now only urgent text message and this notice may include the time period that the recipient sets. As explained above, the method enables the sender to complete the text message according to his own discretion, assuming that he will act according the notice. For completing the text message the method may enables the sender to complete the text message by pressing on a specific button, on the screen or on the keyboard of his mobile device, to say a specific word and any other way that users activates features by their mobile devices. Otherwise, the sender may cancel the sending of the text message or to send it as non-urgent message, means that this text message will be noticeable on the mobile device of the user at the end of said time period that the user sets. In other words, the method provides the sender with the option to complete the sending of the text message and it will be noticeable immediately, to cancel the sending of the text message or to send it now with knowing that the text message will be noticeable at the end of that period of time. Important aspect of the method is that the user is not aware of and is not distracted when a message received and waiting to be shown at the end of said period of time.

The method may provide the users with an option to select the notice out of several optional notices. The method may also provide the users an option to compose a notice. The notice may include the time period in which the recipient prefers to receive only text message in specific matters.

The method enables the recipient to define times in which he wishes to receive only urgent text message. The method also may include the option to define geographical locations in which the recipient will receive only urgent text message, by using the GPS features and the map programs of the mobile device. The recipient may set the method that it will be activated automatically anytime he is in a certain territory, for example, in the school yard of his children, in the park, in the sport club, the church and other places in which the recipient prefer to be in a rest from not-urgent text message.

The notice may be presented on the sender mobile device as a vocalic notice, as a text message, or displayed on the mobile device. As explained above, the user may select the notice from several options or to compose one or more as he or she wishes, for example: “If it is urgent press 1 and I will receive the text message immediately, otherwise, please text to me after 16:00”; “I am now in a movie until 21:00, if urgent, press 1 and I will receive now the text message”; “I am in a meeting, David or Ruth, press 1 and I will receive now the text messages, all the others please text to me after 13:00”; “Trying to sleep early today, urgent matters press 1, otherwise please try tomorrow”. The method may also enable the user to determine in advance that the time period will be presented continuously in specific days and times.

In other words, the notification includes the time frame and the smartphone application may provide the user with an option to select a notification out of several optional notifications and also the option to compose the notification by adding some information, as a text or symbols for example, that will be presented before the senders as to the matters, type of senders or specific senders that are requested or permitted to send their messages immediately as urgent messages. For example, the user can compose the following notification: “Your message will be noticeable for me only today at 16:00; If your message is not urgent then press “send” and I will notice it at 16:00; if your message is urgent then press “urgent” and your message will be noticeable immediately; Any message regarding the school of my son, from my clients and from David or Sara—please send as “urgent”. We may assume that senders will act according the notification.

The smartphone application may be also useful in time of driving or having personal or business meetings. It is known that the average user is unlikely to close the messaging applications in time of driving, due to unreasonable fear that he may miss important messages. In these cases, the user may psychologically allow himself to activate the smartphone application and to set the time frame according the anticipating time of the meeting or the driving. Many users unfortunately permit themselves to look at the mobile devices during driving when they hear the alert of incoming messages, which distract their mind and increase the risk of driving. In such cases, for example, before starting a driving for 2 hours between 10:00 to 12:00, the user may set the time frame as “after 12:00” and thus it is likely that he will receives fewer amounts of messages during driving for his safety.

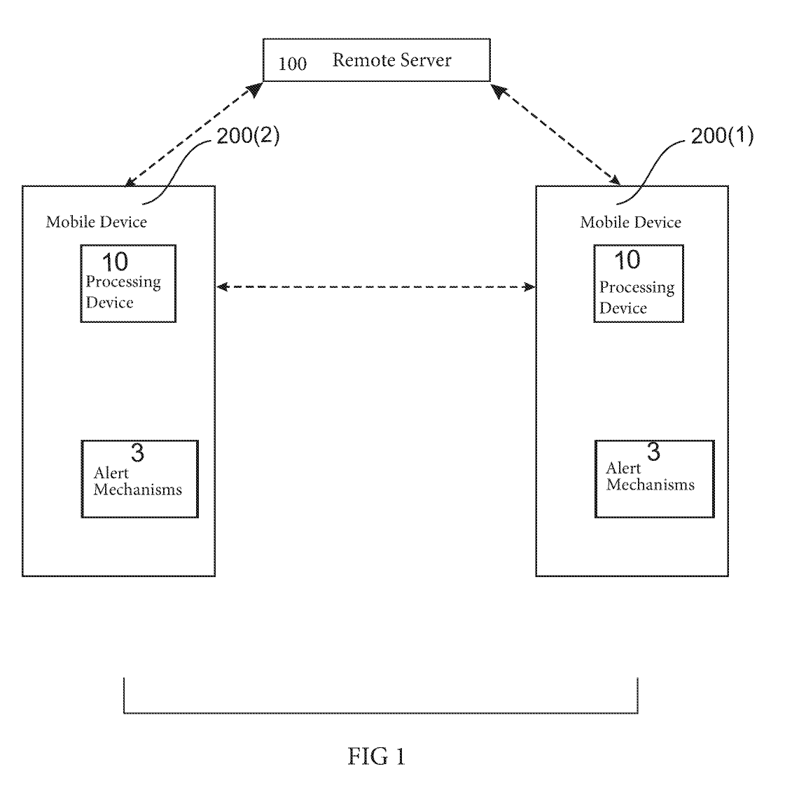

FIG. 1 is a block diagram that shows two mobile devices (200) that one of them is the recipient mobile device (1) and the second one is the sender mobile device (2). The dotted lines between the remote server (100) and the mobile devices (200) refer to internet communication and the dotted line between these two mobile devices (1) and (2) refer to a cellular communication in case of a cellular text messages.

The method that is described above, is the first embodiment of the method subject matter of the present patent application, and this first embodiment method includes in fact a parallel communication between the recipient mobile device and the sender mobile device: the direct communication of the cellular connection, in case of a cellular text message, or over the internet in case of a Skype, messenger, WhatsApp text messages or other kind of phone service provider over internet, and the internet communication between these mobile devices through the remote server as part of the operation of the method. By that, the execution of the first embodiment of the method does not require the cooperation of the phone service providers companies or the mobile devices manufacturers. The term “phone service providers” means any provider that provides services of text messaging, including cellular providers, Skype, Messenger, Viber, WhatsApp providers and the like.

The second embodiment of the method subject matter of the present patent application may be executed, for example, by the manufacturers of mobile devices which may install the method as a built-in program in the processor devices in the mobile devices. The second embodiment of the method performed by a processing device (10) running on the mobile device (200) of the user, and includes the following features:

(a) Enabling the user of a mobile device (11) to manage incoming text messages to his mobile device by enabling the user to activate the method on his mobile device for a period of time that he sets.
(b) In response to the activation of the method on the mobile device, the method prevents the operation of the alerts mechanisms (3) of the mobile device (11) in response to incoming text messages during this period of time.
(c) Storing the information regarding this period of time in the processing device (10) in the mobile device (11).
(d) In response to an incoming text message from another mobile device (22) during said period of time, the method sends a notice to the another mobile device that includes notification that the user prefers to receive now only urgent text message.
(e) Enabling the sender of said incoming text message whether to complete the incoming text message according to his sole discretion.
(f) In response to a decision to complete this incoming text message, the method enables the operation of the alerts mechanisms of the mobile device and by that enabling the user of the mobile device to be aware to this incoming text message.

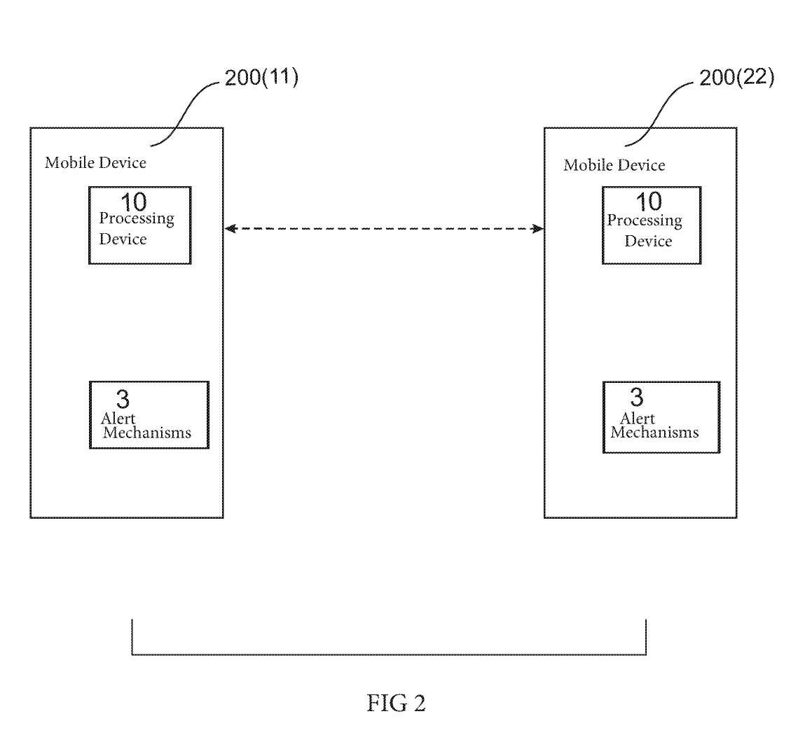

FIG. 2 is a block diagram that shows two mobile devices (200) that one of them is the mobile device (11) and the second one is the another mobile device (22).

The third embodiment of the method subject matter of the present patent application can be executed, for example, by the phone service providers, such as telephone companies, cellular service providers, and other kind of phone service providers, which provides programs and services for text messages over the internet, such as Skype, Viber, ahatsApp, Messenger, which may run the method on their computers. We will refer to all these kinds of text messages service providers in the application and in the claims as “phone service providers”. The third embodiment of the method which performed by processing device running on the computer (500) of the phone service provider, comprising:

(a) Enabling each subscriber of the phone service provider to manage incoming text message to his phone number.
(b) Enabling the subscriber to establish a communication with said computer for activating the method regarding his phone number for a period of time that he sets.
(c) In response to the activation, the method disables for said period of time transmissions of incoming text message to the phone number of this subscriber.
(d) Storing in the computer the information regarding the phone number of the subscriber and listing for said period of time this phone number as a phone number on an urgent mode.
(e) Checking the incoming text message to subscribers of the phone service provider to find out whether one or more of these incoming text messages are directed to this phone number of this subscriber.
(f) In response to an incoming text message to this phone number of the subscriber while said phone number is listing as on urgent mode, the method sends a notice to the mobile device (520) of the sender of this incoming text message that includes notification that this subscriber prefers to receive now only urgent text messages.
(g) Enabling the sender whether to complete this incoming text message according to his sole discretion.
(h) In response to such decision of said sender to complete the incoming text message, the method enables transmission of this incoming text message to the phone number of this subscriber and by that a mobile device (510) of the subscriber may alerts.

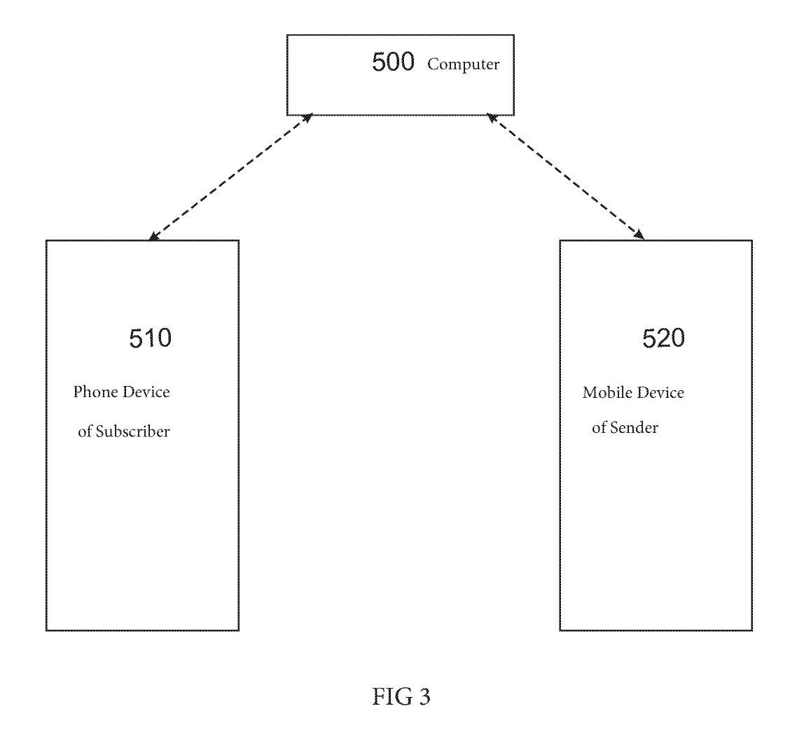

FIG. 3 is a block diagram that shows the computer (500) of the phone service provider, the mobile device (520) and the phone device (510).

What is claimed is:

1. A method performed by processing devices running on a recipient mobile device, a sender mobile device and a remote server, comprising:
enabling a recipient of said recipient mobile device to activate the method regarding said recipient mobile device for a period of time that said recipient sets;
in response to said activation of the method regarding said recipient mobile device, preventing operation of alerts mechanisms of said recipient mobile device in response to incoming text messages during said period of time;
in response to said activation of the method regarding said recipient mobile device, sending to said remote server information regarding a phone number of said recipient mobile device and regarding said period of time;
storing in said remote server said information regarding said phone number of said recipient mobile device and listing for said period of time said phone number as a phone number on an urgent mode;
in response to execution of a text message from said sender mobile device to another phone number, sending from said sender mobile device to said remote server information regarding said another phone number;
checking in said remote server whether said another phone number is listed in said remote server as said phone number on an urgent mode;
in response to a positive result of said checking, sending a notice to said sender mobile device, said notice includes notification that said recipient prefers to receive now only urgent text messages;
enabling a sender of said text message from said sender mobile device to complete said text message according to his sole discretion;
in response to completion of said text message, sending command from said remote server to said recipient mobile device for enabling the operation of said alerts mechanisms of said recipient mobile device and whereby enabling said recipient to be aware to said text message;
whereby enabling said recipient to manage incoming text messages to said recipient mobile device in a way that said incoming text messages will not immediately activate said alerts mechanisms of said recipient mobile device but only as a result of said completion of said text message.

2. A method performed by a processing device running on a mobile device, comprising:
enabling a user of said mobile device to manage incoming text messages to said mobile device by enabling said user to activate the method on said mobile device for a period of time that said user sets;
in response to said activation of the method on said mobile device, preventing operation of alerts mechanisms of said mobile device in response to incoming text messages for said period of time;
storing information regarding said period of time in said processing device in said mobile device;
in response to incoming text message from another mobile device during said period of time, sending a notice to said another mobile device, said notice includes notification that said user prefers to receive now only urgent text messages;
enabling a sender of said incoming text message to complete said text message according to his sole discretion;
in response to completion of said incoming text message, enabling the immediate operation of said alerts mechanisms of said mobile device, whereby enabling said user of said mobile device to be aware to said incoming text message;
whereby enabling said user to manage said incoming text messages to said mobile device in a way that said incoming text messages will not immediately activate said alerts mechanisms of said mobile device but only as a result of said completion of said incoming text messages.

3. A method performed by a processing device running on a computer of a phone service provider, comprising:
enabling subscriber of said phone service provider to manage incoming text messages to his phone number;
enabling said subscriber to establish a communication with said computer for activating the method regarding said phone number for a period of time that said subscriber sets;
in response to said activation, disabling for said period of time transmissions of said incoming text messages to said phone number;
storing in said computer said information regarding said phone number of said subscriber and listing for said period of time said phone number as a phone number on an urgent mode;
checking incoming text messages to subscribers of said phone service provider to find out whether one or more of said incoming text messages to said subscribers are directed to said phone number of said subscriber;
in response to an incoming text message to said phone number of said subscriber while said phone number is listing as on said urgent mode, sending a notice to a sender of said incoming text message, said notice includes notification that said subscriber prefers to receive now only urgent text messages;
enabling said sender to complete said incoming text message according to his sole discretion;
in response to completion of said incoming text message, enabling immediate transmission of said incoming text message to said phone number.
